(19) United States
(12) Patent Application Publication
(10) Pub. No.: US 2015/0052463 A1
(43) Pub. Date: Feb. 19, 2015

(54) INFORMATION PROCESSING METHOD, APPARATUS, AND ELECTRONIC DEVICE

(71) Applicants: Lenovo (Beijing) Co., Ltd., Beijing (CN); Beijing Lenovo Software Ltd., Beijing (CN)

(72) Inventor: Chao Zhang, Beijing (CN)

(73) Assignees: Lenovo (Beijing) Co., Ltd., Beijing (CN); Beijing Lenovo Software Ltd., Beijing (CN)

(21) Appl. No.: 14/229,897

(22) Filed: Mar. 29, 2014

(30) Foreign Application Priority Data
Aug. 19, 2013 (CN) 201310362083.4

(51) Int. Cl. G06F 3/0488; G06F 3/0484

(52) U.S. Cl. CPC G06F 3/0488; G06F 3/0484
USPC 715/765

(57) ABSTRACT

An information processing method, apparatus, and an electronic device are provided. The information processing method includes: obtaining a first input operation by a sensing apparatus, the first input operation corresponding to a first input action; determining the first input action based on the first input operation and generating a first instruction corresponding to the first input action; executing the first instruction for a first object corresponding to the first input operation; determining, based on the first input operation, that the first input action is completed and a gesture at the time of completion of the first input action is maintained; and continuing to execute the first instruction for the first object corresponding to the first input operation.

### CROSS REFERENCE TO RELATED APPLICATION

This application claims priority to Chinese Patent Application No. 201310362083.4, entitled “INFORMATION PROCESSING METHOD, APPARATUS, AND ELECTRONIC DEVICE”, filed on Aug. 19, 2013 with State Intellectual Property Office of PRC, which is incorporated herein by reference in its entirety.

### FIELD

The disclosure relates to the field of information processing technology, and particularly to an information processing method, apparatus, and an electronic device.

### BACKGROUND

At present, more and more users use intelligent electronic devices. The user may use the intelligent electronic device to perform various operations. For example, the user may use a “map” application in the intelligent electronic device to locate the user's current position, and may input a place to be queried into a query box of the “map” application; and after “search” is clicked, a query result is displayed on the map displayed by the sensing apparatus of the intelligent electronic device.

However, in a case where the user queries a general path situation within a range of a place, for example, in a case where it is switched from Beijing to Shanghai, the intelligent electronic device needs to execute a zooming-out instruction firstly, and then displays the path from “Beijing” to “Shanghai” on a display region of a display unit of the intelligent electronic device.

If the user wants to view a specific path of the paths, then the user needs to execute a zooming-in action many times on the sensing apparatus of the intelligent electronic device, and the intelligent electronic device needs to execute a zooming-in instruction corresponding the zooming-in action repeatedly to zoom-in the specific path, and then displays the path after being zoomed in on the display region of the display unit.

As illustrated, the intelligent electronic device accomplishes the instruction execution when one input action is completed, therefore, in a case where the intelligent electronic device executes a same input action many times in a continuous time period, the intelligent electronic device executes the instruction corresponding to the input action separately for several times, thereby increasing the execution time and decreasing the execution efficiency.

### SUMMARY

The disclosure is to provide an information processing method, for solving the problem of increased execution time and reduced execution efficiency resulted in a case where the intelligent electronic device separately executes the instruction for several times when executing a same input action for many times in a continuous time period.

The disclosure further provides an information processing apparatus and an electronic device, to ensure that the above method can be implemented and applied in practice.

The information processing method and apparatus, and the electronic device are described as follows.

In one aspect, an embodiment of the disclosure provides an information processing method applied to an electronic device, the electronic device including a sensing apparatus, the method including:

obtaining a first input operation by the sensing apparatus, the first input operation corresponding to a first input action;

determining the first input action based on the first input operation and generating a first instruction corresponding to the first input action;

executing the first instruction for a first object corresponding to the first input operation;

determining, based on the first input operation, that the first input action is completed and a gesture at the time of completion of the first input action is maintained; and

continuing to execute the first instruction for the first object corresponding to the first input operation.

Preferably, in a case where the first instruction is a zooming-in instruction or a zooming-out instruction, the determining the first input action based on the first input operation and generating a first instruction corresponding to the first input action includes:

obtaining a first trajectory generated by a first operating element and a second trajectory generated by a second operating element;

judging a variation trend of a distance between the first operating element and the second operating element according to the first trajectory and the second trajectory;

in a case where it is judged according to the first trajectory and the second trajectory that the distance between the first operating element and the second operating element increases, determining the first input action as a zooming-in action and generating a zooming-in instruction; and

in a case where it is judged according to the first trajectory and the second trajectory that the distance between the first operating element and the second operating element decreases, determining the first input action as a zooming-out action and generating a zooming-out instruction, wherein one or more operating points forming the first trajectory and one or more operating points forming the second trajectory belong to a first part of the operating points for the first input operation.

Preferably, the determining, based on the first input operation, that the first input action is completed and a gesture at the time of completion of the first input action is maintained includes:

obtaining multiple first operating points of the first operating element and multiple second operating points of the second operating element, a starting operating point of the multiple first operating points being an operating point at the end of the first trajectory, a starting operating point of the multiple second operating points being an operating point at the end of the second trajectory, and the multiple first operating points and the multiple second operating points belonging to a second part of the operating points for the first input operation; and

in a case where a predetermined condition is satisfied by the multiple first operating points and the predetermined condition is satisfied by the multiple second operating points, determining that the first input action is completed and the gesture at the time of completion of the first input action is maintained.

Preferably, the executing the first instruction for a first object corresponding to the first input operation includes:

determining a reference point for the first object according to a center point between a starting point of the first trajectory and a starting point of the second trajectory;

determining a factor for responding to the first instruction according to the first trajectory and the second trajectory; and

responding to the first instruction according to the reference point and the factor,

wherein the starting point of the first trajectory and the starting point of the second trajectory are operating points corresponding to a time point when the first operating element and the second operating element are sensed by the sensing apparatus simultaneously.

Preferably, in a case where the first input action is completed and the gesture at the time of the completion of the first input action is maintained, the continuing to execute the first instruction for the first object corresponding to the first input operation includes:

continuing to respond to the first instruction with a predetermined factor based on the reference point.

Preferably, the method further includes:

determining an accomplishment of the first input operation; and

upon accomplishment of the first input operation, moving according to a center point of a display region of a display unit of the electronic device, the first object which is in response to the completion of the first instruction, so that a reference point for the first object corresponds to the center point.

In another aspect, an embodiment of the disclosure provides an information processing apparatus applied to an electronic device, the electronic device including a sensing apparatus, the information processing apparatus including:

an obtaining unit, adapted to obtain a first input operation by the sensing apparatus, the first input operation corresponding to a first input action;

a generation unit, adapted to determine the first input action based on the first input operation and generate a first instruction corresponding to the first input action;

an execution unit, adapted to execute the first instruction for a first object corresponding to the first input operation; and

a determination unit, adapted to determine, based on the first input operation, that the first input action is completed and a gesture at the time of completion of the first input action is maintained, and trigger the execution unit to continue to execute the first instruction for the first object corresponding to the first input operation.

Preferably, in a case where the first instruction is a zooming-in instruction or a zooming-out instruction, the generation unit includes:

an obtaining sub-unit, adapted to obtain a first trajectory generated by a first operating element and a second trajectory generated by a second operating element;

a judgment sub-unit, adapted to judge a variation trend of a distance between the first operating element and the second operating element according to the first trajectory and the second trajectory;

a first generation sub-unit, adapted to determine the first input action as a zooming-in action and generate a zooming-in instruction, in a case where it is judged according to the first trajectory and the second trajectory that the distance between the first operating element and the second operating element increases; and

a second generation sub-unit, adapted to determine the first input action as a zooming-out action and generating a zooming-out instruction, in a case where it is judged according to the first trajectory and the second trajectory that the distance between the first operating element and the second operating element decreases, wherein one or more operating points forming the first trajectory and one or more operating points forming the second trajectory belong to a first part of the operating points for the first input operation.

Preferably, the determination unit includes:

a point obtaining sub-unit, adapted to obtain multiple first operating points of the first operating element and multiple second operating points of the second operating element, a starting operating point of the multiple first operating points being an operating point at the end of the first trajectory, a starting operating point of the multiple second operating points being an operating point at the end of the second trajectory, and the multiple first operating points and the multiple second operating points belonging to a second part of the operating points for the first input operation; and

a determination sub-unit, adapted to determine that the first input action is completed and a gesture at the time of completion of the first input action is maintained, in a case where a predetermined condition is satisfied by the multiple first operating points and the predetermined condition is satisfied by the multiple second operating points.

Preferably, the execution unit includes:

a point determination sub-unit, adapted to determine a reference point for the first object according to a center point between a starting point of the first trajectory and a starting point of the second trajectory;

a factor determination sub-unit, adapted to determine a factor for responding to the first instruction according to the first trajectory and the second trajectory; and

an execution sub-unit, adapted to respond to the first instruction according to the reference point and the factor,

wherein the starting point of the first trajectory and the starting point of the second trajectory are operating points corresponding to a time point when the first operating element and the second operating element are sensed by the sensing apparatus simultaneously.

Preferably, the execution sub-unit is further adapted to continue to respond to the first instruction based on the reference point with a predetermined factor.

Preferably, the information processing apparatus further includes:

an operation obtaining unit, adapted to determine an accomplishment of the first input operation; and

a moving unit, adapted to move, upon accomplishment of the first input operation, the first object which is in response to the completion of the first instruction according to a center point of a display region of a display unit of the electronic device, so that a reference point for the first object corresponds to the center point.

In yet another aspect, an embodiment of the disclosure provides an electronic device including a sensing apparatus, wherein the electronic device further including the above information processing apparatus.

As can be known from the above technical solutions, with the information processing method provided by the embodiments of the invention, after a first instruction is executed for a first object corresponding to a first input operation, it is determined based on the first input operation that the first input action is completed and a gesture at the time of completion of the first input action is maintained, and the first instruction continues to be executed for the first object corresponding to the first input operation. That is, in a case where it is detected by the electronic device that the first input action is completed and the gesture at the time of the completion of the first input action is still maintained, the first instruction may be executed repeatedly for the first object in a continuous time period, thereby achieving an effect that one first input operation corresponds to multiple executions of the first instruction. Compared with a case that one first input operation corresponds to one execution of the first instruction, the execution time is reduced and the execution efficiency is improved.

### BRIEF DESCRIPTION OF THE DRAWINGS

For more clearly illustrating the technical solutions in embodiments of the disclosure, drawings referred to describe the embodiments will be briefly described hereinafter. Apparently, the drawings in the following description are only some embodiments of the disclosure, and for those skilled in the art, other drawings may be obtained based on these drawings without any creative efforts.

FIG. 1 is a flow chart of an information processing method provided by an embodiment of the disclosure;

FIG. 2 is a schematic diagram showing a first input operation;

FIG. 3 is another schematic diagram showing a first input operation;

FIG. 4 is another flow chart of an information processing method provided by an embodiment of the disclosure;

FIG. 5 is yet another schematic diagram showing a first input operation;

FIG. 6 is yet another schematic diagram showing a first input operation;

FIG. 7 is yet another schematic diagram showing a first input operation;

FIG. 8 is yet another flow chart of an information processing method provided by an embodiment of the disclosure;

FIG. 9 is a schematic diagram showing that a first object is displayed;

FIG. 10 is another schematic diagram showing that a first object is displayed;

FIG. 11 is a schematic structural diagram of an information processing apparatus provided by an embodiment of the disclosure;

FIG. 12 is a schematic structural sub-diagram of an information processing apparatus provided by an embodiment of the disclosure;

FIG. 13 is another schematic structural sub-diagram of an information processing apparatus provided by an embodiment of the disclosure; and

FIG. 14 is another schematic structural diagram of an information processing apparatus provided by an embodiment of the disclosure.

### DETAILED DESCRIPTION

First, an information processing method according to an embodiment of the disclosure is introduced simply. The information processing method is applied to an electronic device that includes a sensing apparatus. The information processing method according to the embodiment includes:

obtaining a first input operation by the sensing apparatus, the first input operation corresponding to a first input action;

determining the first input action based on the first input operation and generating a first instruction corresponding to the first input action;

executing the first instruction for a first object corresponding to the first input operation;

determining, based on the first input operation, that the first input action is completed and a gesture at the time of completion of the first input action is maintained; and

continuing to execute the first instruction for the first object corresponding to the first input operation.

Through the information processing method according to the embodiment of the disclosure, in the case where it is detected that the first input action is completed and the gesture at the time of the completion of the first input action is still maintained, the electronic device may execute the first instruction repeatedly for the first object during a continuous time period, thereby decreasing the execution time and increasing the execution efficiency.

Further, a reference point for the first object on which the first instruction is executed for the first time may also be determined in the case where the first instruction is a zoom-in instruction or a zoom-out instruction, and the first instruction, during subsequent continuing execution of the first instruction on the first object, may continue to be executed on the first object based on the reference point. Since each execution process of the first instruction is based on the reference point, it may be ensured that the reference point for the first object is always displayed on a display area of a display unit of the electronic device. Moreover, continuing execution of the first instruction on the first object is based on the determined reference point, which further reduces the execution time and improves the execution efficiency, compared with the case where each execution of the first instruction needs a recalculate of the reference point.

The technical solution according to the embodiments of the disclosure will be described clearly and completely as follows in conjunction with the drawings. It is obvious that the described embodiments are only some of the embodiments according to the disclosure. Other embodiments obtained by those skilled in the art based on the embodiments in the disclosure without any creative work fall into the scope of the disclosure.

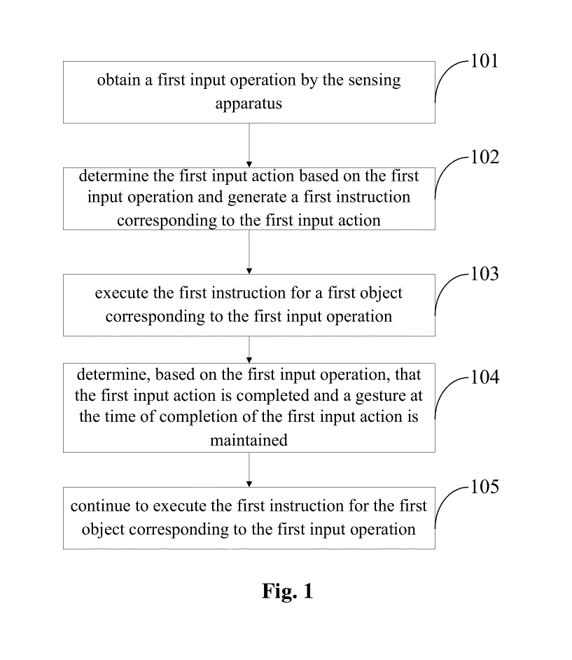

Referring to FIG. 1, a flowchart of an embodiment of an information processing method according to the disclosure is shown. The information processing method is applied to an electronic device including a sensing apparatus. The information processing method may include the following steps 101 to 105.

Step 101: obtaining a first input operation by the sensing apparatus, the first input operation corresponding to a first input action.

It may be understood that in a case where one or more operating elements perform an operation on the display region of the display unit of the electronic device, the first input operation is associated with the number of operating elements sensed by the sensing apparatus and a series of the operating points formed on the display region of the display unit of the electronic device. If the operating element performs different operations on the display region of the display unit of the electronic device, the first input operations obtained by the sensing apparatus are also different. As used herein, the term “operating element” refers to any object that may operate on the display unit, such as a finger, a stylus, a pointing device or the like, and the disclosure is not limited herein.

As an example, in the case where a user zooms-in a picture displayed on the display area of the display unit, the sensing apparatus may sense that there exist two operating elements, which are operating on the picture, on the display area of the display unit. Moreover, the sensing apparatus may acquire multiple operating points formed on the display area of the display unit of the electronic device by each of the operating elements. The multiple operating points by each of the operating elements form a line segment, a formation process of the line segment indicates a movement trajectory of the operating element.

When the user clicks on a button of the display area of the display unit, the sensing apparatus may sense that there exists one operating element, which is operating, on the display area of the display unit. Moreover, when the user clicks on the button, the sensing apparatus may acquire an operating point formed on the display area of the display unit of the electronic device by the operating element.

Step 102: determining the first input action based on the first input operation and generating a first instruction corresponding to the first input action.

In the case where different operations are executed on the display area of the display unit of the electronic device by the operating elements, the sensing apparatus obtains different first input operations. Moreover, each of the first input operations corresponds to one first input action, and each first input action corresponds to one first instruction, therefore the first input action and the first instruction corresponding to the first input action may be determined through a judgment on the first input operation.

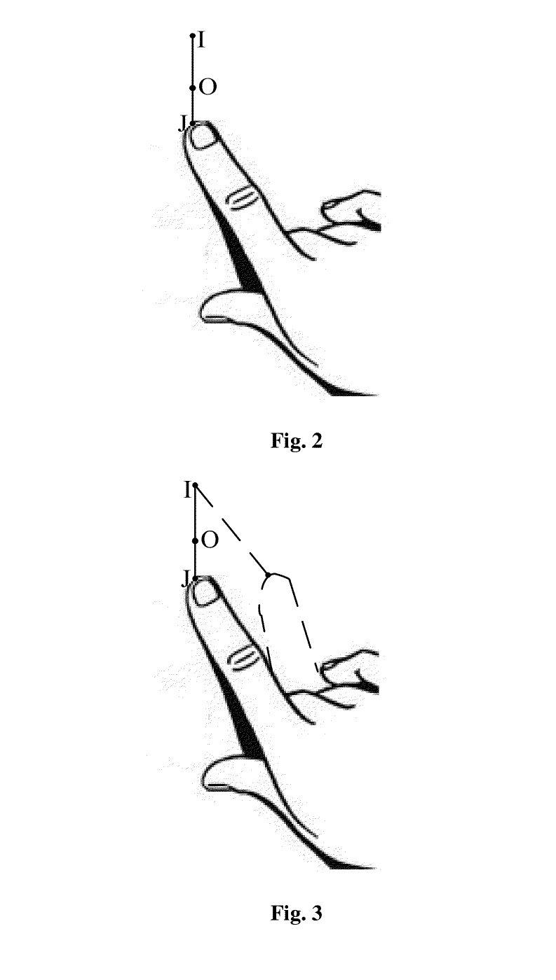

In the case where the first input operation is associated with one operating element, operation points with different time intervals and different distances are formed on the display area of the display unit of the electronic device when different first input operations are executed by the operating element. As an example, when the first input operation is a sliding operation as shown in FIG. 2, the distance between the first operating point I and the last operating point J is greater than that when the first input operation is a single-click operation. Therefore the first input action and the first instruction may be determined by the sensing apparatus according to the time interval and the distance, which is as follows:

in a case where the time interval between the operating points sequentially formed by the operating element is less than a preset time interval, it is determined that the first input action is a double-click action and a double-click instruction is generated.

In a case where the time interval between the operating points sequentially formed by the operating element is greater than a preset time interval, a distance between a first operating point and a last operating point formed by the operating element is further to be acquired; in a case where the distance between the first operating point and the last operating point is greater than the preset distance, it is determined that the first input action is a sliding action and a sliding instruction is generated; in a case where the distance between the first operating point and the last operating point is less than the preset distance, it is determined that the first input action is a single-click action and a single-click instruction is generated.

Further, if the first input action is determined to be the sliding action, a movement trajectory of the first input operation may be also determined by the sensing apparatus according to a sequence for the forming of the operating points, and the movement trajectory of the first input operation may act as a movement trajectory of the sliding action and a movement trajectory of the sliding instruction. As shown in FIG. 2, an order in which operating points are formed on the display area of the display unit of the electronic device by the operating element is orderly I-O-J, therefore, the movement trajectory of the first input operation is from up to down, the action trajectories of the sliding action and the sliding instruction are also from up to down, and a first object moves downward when the sliding instruction is executed on the first object.

In the embodiment of the disclosure, the preset time interval is the maximum time interval between the forming of two operating points in the case of a double-click operation, and the preset time interval may take different values for different operating elements. The preset distance may be the maximum width of an area formed by the operating element fully contacting with the display area of the display unit.

Step 103: executing the first instruction for a first object corresponding to the first input operation.

Specifically, the first object is an object for the operation performed by the operating element on the electronic device. As an example, in the case where the operating element operates on a picture displayed on the display area of the display unit, the picture is the first object corresponding to the first input operation. In the case where the operating element operates on a button on the electronic device, the button is the first object corresponding to the first input operation.

Step 104: determining, based on the first input operation, that the first input action is completed and a gesture at the time of completion of the first input action is maintained.

In the embodiment of the disclosure, after the first input action is completed, the sensing apparatus may still sense that the operating element forms the operating points on the display area of the display unit of the electronic device, as shown in FIG. 2. Although the sliding action is completed, the operating element does not leave the display area of the display unit, and still forms operating points on the display area of the display unit. At this time, the sensing apparatus may determine, according to operating points formed on the display area of the display unit, whether a gesture at the time of the completion of the first input action is maintained.

FIG. 2 is still taken as an example, after the first input action is completed, the operating element stays on the display area of the display unit. Due to uneven force exerted by the operating element itself, different sensitivity of the sensing apparatus and the like, the sensing apparatus may obtain multiple operating points of the operating element during the stay.

After obtaining multiple operating points and multiple second operating points, the sensing apparatus also needs to further judge whether a predetermined condition is satisfied by the multiple operating points. In the case where the predetermined condition is satisfied by the multiple operating points, it is indicated that the multiple operating points are formed in a special small area due to uneven force exerted by the operating element itself and different sensitivity of the sensing apparatus, thereby determining that the first input action is completed and a gesture at the time of completion of the first input action is maintained.

It is assumed that the operating element shown in FIG. 2 changes to a broken line shown in FIG. 3 before the last operating point is formed, at this time, operation region for the multiple operating points becomes large, and the predetermined condition is not satisfied by the multiple operating points, thereby determining that the first input action is completed but a gesture at the time of the completion of the first input action is not maintained.

Specifically, judging whether the operating points are formed in a small area may be executed by judging whether a difference between the operating points formed sequentially is within a preset range. If the different is within the preset range, it is judged that the operating points are formed in the small area. Specifically, the preset range is the minimum tolerance for the operating points in determining that the gesture at the time of the completion of the first input action is maintained, which may take different values for different application scenarios.

Step 105: continuing to execute the first instruction on the first object corresponding to the first input operation.

In the case of determining that the first input action is completed and a gesture at the time of completion of the first input action is maintained, the first instruction continues to be executed on the first object corresponding to the first input operation. In the case where the electronic device detects that the operating element still maintains a gesture at the time of the completion of the first input action after a zoom-in instruction is executed on a picture once, the zoom-in instruction continues to be executed on the picture.

It can be seen from the above technical solution that the electronic device may execute repeatedly, in the case where it is detected that the first input action is completed and the gesture at the time of the completion of the first input action is still maintained, the first instruction on the first object until the gesture at the time of the completion of the first input action is not maintained, thereby achieving an effect that one first input operation correspond to multiple executions of the first instruction. Compared with a case that one first input operation corresponds to one execution of the first instruction, the execution time is reduced and the execution efficiency is improved.

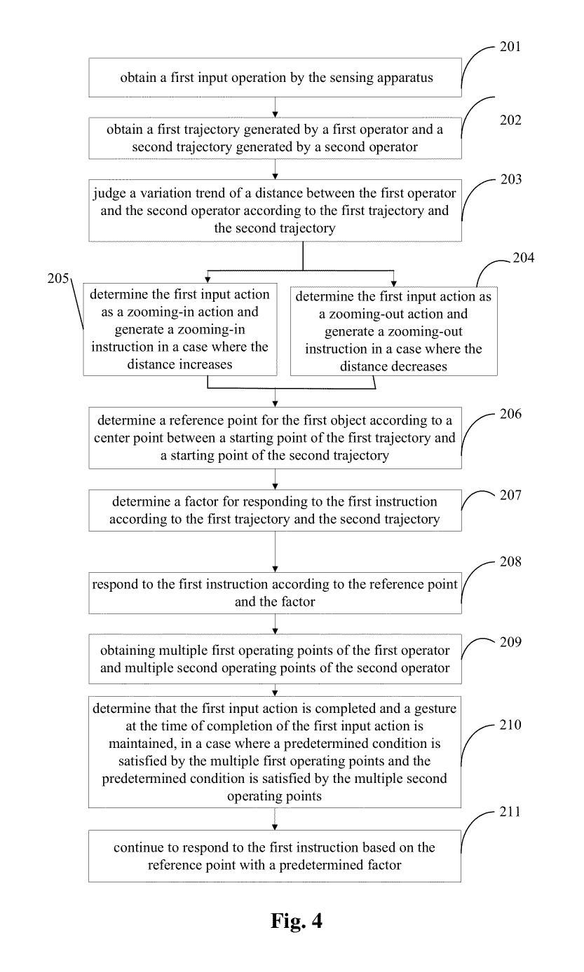

Reference is made to FIG. 4 which illustrates another flow chart of an information processing method provided by an embodiment of the disclosure. The information processing method corresponding to the flow chart aims at a case that a first instruction is a zooming-in instruction or a zooming-out instruction. The method may include steps 201 to 211.

Step 201: obtaining a first input operation by a sensing apparatus, the first input operation corresponding to a first input action.

Step 202: obtaining a first trajectory generated by a first operating element and a second trajectory generated by a second operating element.

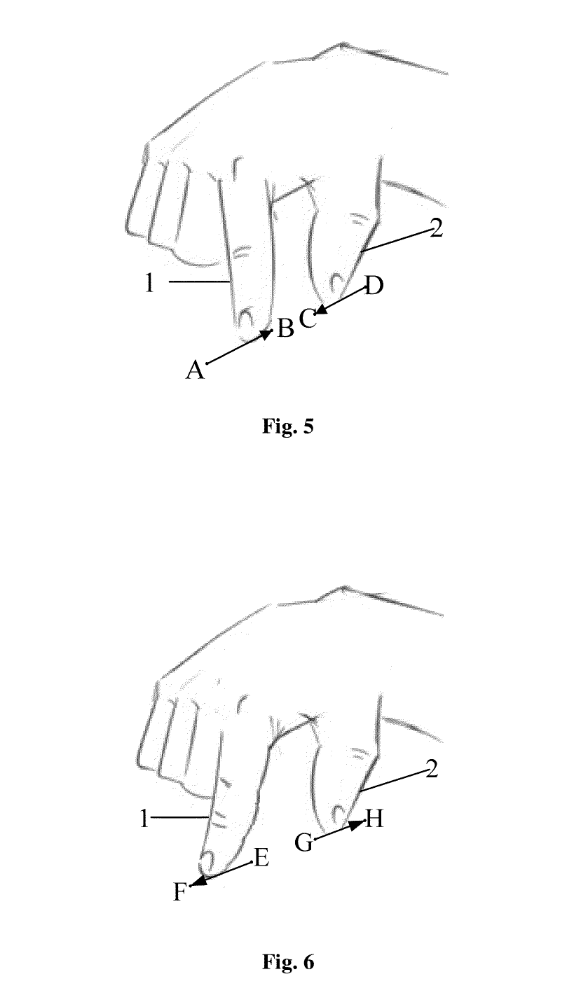

A feasible implementation for step 102 is described below in conjunction with FIGS. 5 and 6. In FIG. 5, during a movement of the first operating element 1 for the first input operation from an operating point A to an operating point B, the first operating element 1 forms a series of operating points (not shown). These operating points along with the operating point A and the operating point B constitute the first trajectory of the first operating element 1, and a corresponding arrow in FIG. 5 represents the motion trajectory of the first operating element 1.

During the movement of the second operating element 2 for the first input operation from an operating point C to an operating point D, the second operating element 2 forms a series of operating points (not show) on a display region of a display unit of an electronic device. These operating points along with the operating point C and the operating point D form the second trajectory of the second operating element 2, and a corresponding arrow in FIG. 5 represents the motion trajectory of the second operating element 2.

Similarly, in FIG. 6, the movement of the first operating element 1 for the first input operation from an operating point E to an operating point F also generates the first trajectory, and the movement of the second operating element 2 from an operating point G to an operating point H also generates the second trajectory. When the first operating element 1 and the second body 2 perform the input operation illustrated in FIG. 5 or FIG. 6, the sensing apparatus may obtain the first trajectory generated by the first operating element and the second trajectory generated by the second operation.

Step 203: judging a variation trend of a distance between the first operating element and the second operating element, according to the first trajectory and the second trajectory.

After acquiring the first trajectory and the second trajectory, the sensing apparatus may further judge the variation trend of the distance between the first operating element and the second operating element according to the first trajectory and the second trajectory. The variation trend of the distance between the first operating element and the second operating element is judged by computing distances between the operating points constituting the first trajectory and the operating points constituting the second trajectory in an order of the forming of the operating points.

Taking FIG. 5 as an example, a first operating point of the first trajectory is A, a first operating point of the second trajectory is C, and a distance between the two points is indicated by AC. A last operating point of the corresponding first trajectory is B, a last operating point of the corresponding second trajectory is D, and a distance between the two points is indicated by BD. By comparing the distance AC to the distance BD, it can be seen from that the distance variation between the first operating element and the second operating element in FIG. 5 is changing from small to large.

Step 204: determining the first input action as a zooming-in action and generating a zooming-in instruction, in the case where it is judged according to the first trajectory and the second trajectory that the distance between the first operating element and the second operating element increases, and proceeding to step 206.

Step 205: determining the first input action as a zooming-out action and generating a zooming-out instruction, in a case where it is judged according to the first trajectory and the second trajectory that the distance between the first operating element and the second operating element decreases, and proceeding to step 206.

Step 206: determine a reference point for the first object according to a center point between a starting point of the first trajectory and a starting point of the second trajectory.

In some cases, the first operating element and the second operating element do not contact the display region of the display unit simultaneously. At this time, the operating point obtained by the sensing apparatus is not taken as a point constituting the first trajectory or the second trajectory. In the embodiments of the disclosure, the starting point of the first trajectory and the starting point of the second trajectory are the points corresponding to a time point when the first operating element and the second operation are sensed by the sensing apparatus simultaneously. As shown in FIG. 5, the starting point of the first trajectory is A, the starting point of the second trajectory is C, and therefore the center point of a line between the point A and C is marked as the reference point for the object.

It should be noted that, when the operating elements execute the first input operation, because it is not ensured that a distance from the starting point of the first trajectory to a position in which an user is really most interested and a distance from the starting point of the second trajectory to the position in which the user is really most interested are equal, the reference point obtained by averaging the two starting point may deviate from the position in which the user is really most interested.

Of course, the reference point for the first object may also be a reference point for the display region of the display unit. Before the information processing method provided by the embodiments of the disclosure is executed, the first object is moved firstly so that the reference point for the first object is moved to the reference point for the display region of the display unit. In order to make the reference point for the first object overlap with the reference point for the display region of the display unit, a marker which is used to prompt the user of the reference point for the display region of the display unit is displayed firstly on the display region of the display unit before the method for information processing provided by the embodiments of the disclosure is executed. The user may move the reference point for the first object to the marker, to make the reference of the first object overlap with the reference point for the display region of the display unit as much as possible.

Step 207: determining a factor for responding to the first instruction according to the first trajectory and the second trajectory. Specifically, the factor for the first instruction is determined by the distances between the counterpart operating points constituting the first trajectory and the second trajectory. For example, the factor for an i-th execution of the first instruction is determined by a distance between an i-th operating point of the first trajectory and an i-th operating point of the second trajectory.

In the case where the first instruction is the zooming-in instruction, the distance between the operating points of the two trajectories becomes larger, the factor for the zooming-in becomes larger. In the case where the first instruction is the zooming-out instruction, the distance between the operating points of the two trajectories becomes smaller, the factor for the zooming-out becomes larger.

Step 208: responding to the first instruction according to the reference and the factor.

Conventionally, before each execution of the zooming-in instruction or the zooming-out instruction, the reference point for the first object corresponding to the instruction executed for this time needs to be recalculated. However, for the embodiments of the disclosure, already obtained the reference point is used when the first instruction is responded to, thereby saving time.

Step 209: acquiring multiple operating points of the first operating element and multiple operating points of the second operating element.

In the embodiments of the disclosure, after the first input action is completed, the operating point formed on the display region of the display unit of the electronic device by the operating elements may be still sensed by sensing apparatus. As shown in FIG. 5, While the zooming-out action is completed, the first operating element and the second operating element do not leave the display region of the display unit, and the first operating element and the second operating element still form operating points on the display region of the display unit. At this time, the sensing apparatus may determine whether the gesture at the time of the completion of the first input action is maintained according to the operating points formed on the display region of the display unit of the electronic device by the operating elements.

Still taking FIG. 5 as an example, after the first input action is completed, the first operating element 1 and the second operating element 2 stay on the display region of the display unit. Due to the uneven force exerted by the first operating element 1 and the second operating element 2, and the different sensitivity of the sensing apparatus and so on, multiple first operating points of the first operating element 1 and multiple second operating points of the second operating element 2 may be obtained by the sensing apparatus during a period when the first operating element 1 and the second operating element 2 stay on the display region of the display unit. The starting operating point of the multiple first operating points is the operation point at the end of the first trajectory, and the starting operating point of the multiple second operating points is the operation point at the end of the first trajectory. That is, for example, the operating point B in FIG. 5 is the operation point at the end of the first trajectory, and the operating point B is the starting operating point of the multiple second operating points, which indicate that the first input action is completed and a gesture at the time of the completion of the first input action begins to be maintained.

Step 210: determining that the first input action is completed and a gesture at the time of completion of the first input action is maintained, in a case where a predetermined condition is satisfied by the multiple first operating points and the predetermined condition is satisfied by the multiple second operating points.

The sensing apparatus may further need to judge whether the multiple first operating points and the multiple second operating points satisfy the predetermined condition when acquiring the multiple first operating points and the multiple second operating points. In the case where a predetermined condition is satisfied by the multiple first operating points and the multiple second operating points satisfy the predetermined condition, it indicates that the multiple first operating points and the multiple second operating points are operating points formed in a small region due to the uneven force exerted by the operation bodies themselves and the different sensitivity of the device, and thereby determining that the first input action is completed and a gesture at the time of the completion of the first input action is maintained.

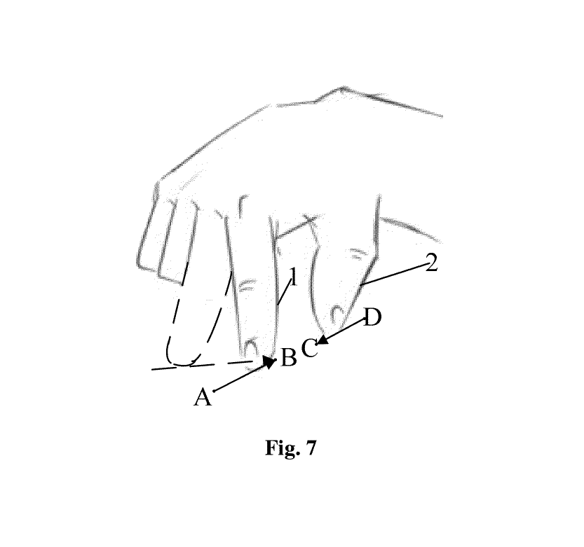

It is assumed that the first operating element 1 in the first input operation as shown in FIG. 5 is changed to the position indicated by a broken line shown in FIG. 7 before the last operating point is formed, at this time, the operation region of the multiple first operating points becomes large, and the multiple first operating points do not satisfy the predetermined condition, thereby determining that the first input action is completed but a gesture at the time of the completion of the first input action is not maintained.

Specifically, judging whether the operating points are formed in a small area may be executed by judging whether a difference between the operating points formed sequentially is within a preset range. If the different is within the preset range, it is judged that the operating points are formed in the small area. Specifically, the preset range is the minimum tolerance for the operating points in determining that the gesture at the time of the completion of the first input action is maintained, which may take different values for different application scenarios.

It should be noted that the sensing apparatus may obtain a serial of operating points formed respectively by the first operating element and the second operating element in the first input operation on the display region of the display unit of the electronic device. The operating points constituting the first trajectory and the operating points constituting the second trajectory belong to a first part of the operating points of the first input operation. The multiple first operating points and the multiple second operating points corresponding to a time point when it is determined that the first input action is completed and a gesture at the time of the completion of the first input action is maintained belong to a second part of operating point of the first input operation. And the first part of operating point and second part of operating point share two same operating points. One of the two same operating points is not only the operating point at the end of the first trajectory but also the starting operating point of the multiple first operating points; and the other is not only the operating point at the end of the second trajectory but also the starting operating point of the multiple second operating points.

Step 211: continuing to respond to the first instruction with a predetermined factor based on the reference point.

The preset factor may be a factor preset previously for the first instruction. Of course, the preset factor may be a factor for executing the first instruction at the time of the completion of the first input action, which is not limited in the embodiment of the disclosure.

Moreover, conventionally, before each execution of the zooming-in instruction or the zooming-out instruction, the reference point for the first object corresponding to the zooming-in instruction or the zooming-out instruction need to be recalculated. In the actual calculation, there is accumulative error in each calculation, and the reference point for the first object obtained after being calculated for several times may be not the position in which the user is most interested. At this time, there is a need to further execute a sliding instruction such that the position in which the user is most interested is displayed on the display region of the display.

However, the information processing method provided by the embodiments of the disclosure continue to execute the first instruction still based on the reference point obtained previously when the operating elements are maintained at the gesture at the time of the completion of the first input action. That is to say, the executions of the first instruction in the embodiments of the disclosure are all based on the reference point for the first object determined when the first instruction is executed for the first time. Because the reference point obtained from the first execution is closer to the position in which the user is most interested, the first instruction is executed on the region around the reference point of the first object such that the reference point for the first object are always displayed on the display region of the display unit as much as possible.

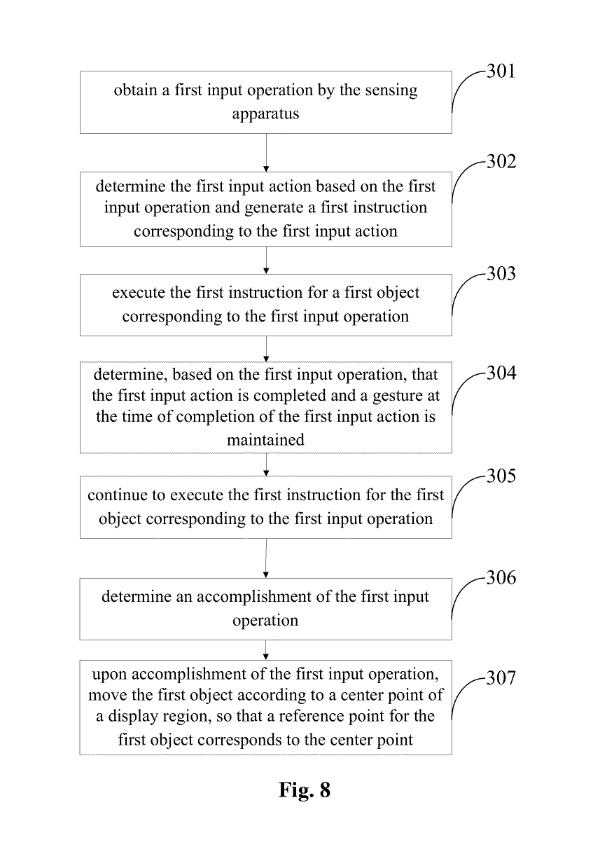

Reference is made to FIG. 8 which shows yet another flowchart of an information processing method according to an embodiment of the disclosure. In a case where the first instruction is a zoom-in instruction or a zooming-out instruction, the first information processing method corresponding to the flowchart may include steps 301 to 307:

Step 301: obtaining a first input operation by a sensing apparatus, the first input operation corresponding to a first input action.

Step 302: determining the first input action based on the first input operation and generating a first instruction corresponding to the first input action.

Step 303: executing the first instruction for a first object corresponding to the first input operation.

Step 304: determining, based on the first input operation, that the first input action is completed and a gesture at the time of completion of the first input action is maintained.

Step 305: continuing to execute the first instruction for the first object corresponding to the first input operation.

Step 306: determining an accomplishment of the first input operation.

Upon accomplishment of the first input operation, an operating element departs from a display region of a display unit of an electronic device, and therefore the first instruction is accomplished accordingly.

Step 307: upon accomplishment of the first input operation, moving, according to a center point of a display region of a display unit of the electronic device, the first object which is in response to the completion of the first instruction, so that a reference point for the first object corresponds to the center point.

According to the embodiment of the disclosure, although a continuing execution of the first instruction for the first object based on the reference point may ensure that the reference point for the first object is displayed on the display region of the display unit as much as possible, the execution of the first instruction based on the reference point for the first object may cause that an image region including the reference point is moved out of the display region of the display unit and can not be displayed completely. Therefore, when the first input operation is accomplished, by moving the first object and making the reference point for the first object overlap with the center point of the display region of the display unit of the electronic device, the image region including the reference point may be displayed as completely as possible.

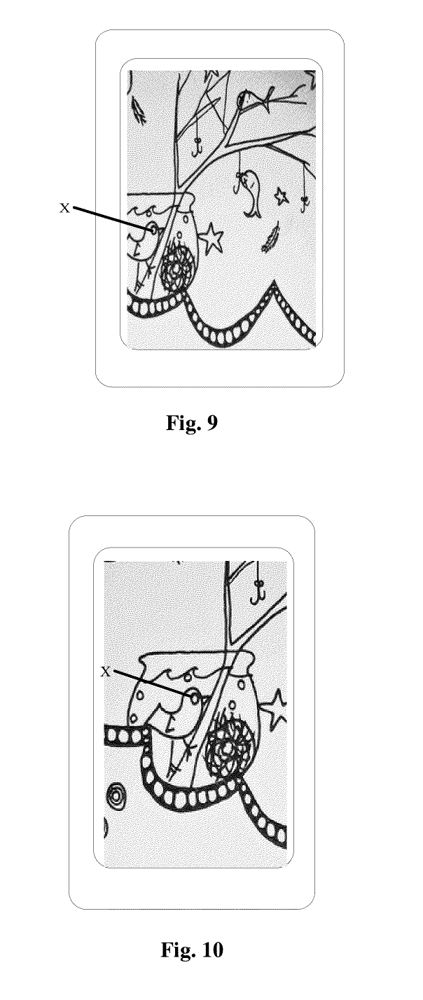

As shown in FIG. 9, after the execution of the first instruction for the first object, the reference point X for the first object is moved to an edge or corner of the display region. After the first input operation is accomplished, the reference point X for the first object is moved to the center of the display region, as shown in FIG. 10.

Corresponding to the above-described embodiment of the method, the embodiment of the disclosure also provides an information processing apparatus which is applied to an electronic device including a sensing apparatus. Reference is made to FIG. 11 which shows a schematic structure diagram of the information processing apparatus. The information processing apparatus includes an obtaining unit 11, a generation unit 12, an execution unit 13 and a determination unit 14.

The obtaining unit 11 is adapted to obtain a first input operation by the sensing apparatus, the first input operation corresponding to the input first action.

It may be understood that in a case where one or more operating elements perform an operation on the display region of the display unit of the electronic device, the first input operation is associated with the number of operating elements sensed by the sensing apparatus and a series of the operating points formed on the display region of the display unit of the electronic device. If the operating element performs different operations on the display region of the display unit of the electronic device, the first input operation obtained by the sensing apparatus is also different.

The generation unit 12 is adapted to determine the first input action based on the first input operation, and generate a first instruction corresponding to the first input action.

In the case where different operations are executed on the display area of the display unit of the electronic device by the operating elements, the sensing apparatus obtains different first input operations. Moreover, each of the first input operations corresponds to one first input action, each of the first input actions corresponds to one first instruction, therefore the first input action and the first instruction corresponding to the first input action may be determined by a judgment on the first input operation.

In a case where the first input operation is associated with one operating element, operation points with different time intervals and different distances are formed on the display area of the display unit of the electronic device when different first input operations are executed by the operating element. Therefore, the first input action and the first instruction may be determined by the sensing apparatus according to the time interval and the distance, which is described in detail as follows:

in a case where the time interval between the operating points sequentially formed by the operating element is less than a preset time interval, it is determined that the first input action is a double-click action and a double-click instruction is generated; and

in a case where the time interval between the operating points sequentially formed by the operating element is greater than a preset time interval, a distance between a first operating point and a last operating point formed by the operating element is further to be acquired; in a case where the distance between the first operating point and the last operating point is greater than the preset distance, it is determined that the first input action is a sliding action and a sliding instruction is generated; in a case where the distance between the first operating point and the last operating point is less than the preset distance, it is determined that the first input action is a single-click action and a single-click instruction is generated.

Further, if the first input action is determined to be the sliding action, a movement trajectory of the first input operation may be also determined by the sensing apparatus according to a sequence for the forming of the operating points, and the movement trajectory of the first input operation may act as a movement trajectory of the sliding action and a movement trajectory of the sliding instruction.

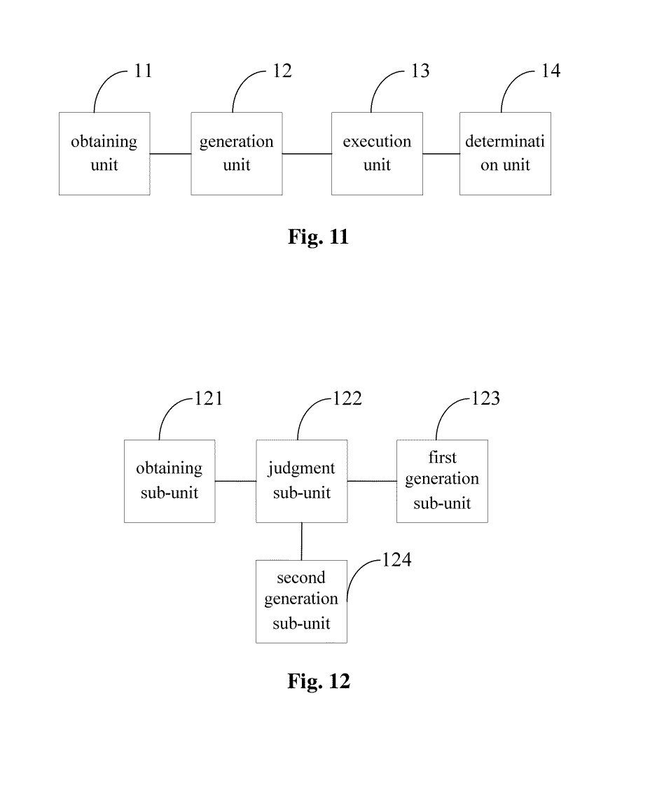

Further, the generation unit 12 may also takes a structure as shown in FIG. 12, which may include: an obtaining sub-unit 121, a judgment sub-unit 122, a first generation sub-unit 123 and a second generation sub-unit 124.

The obtaining sub-unit 121 is adapted to obtain a first trajectory generated by a first operating element and a second trajectory generated by a second operating element.

The judgment sub-unit 122 is adapted to judge a variation trend of a distance between the first operating element and the second operating element according to the first trajectory and the second trajectory.

The first generation sub-unit 123 is adapted to determine the first input action as a zooming-in action and generate a zooming-in instruction, in a case where it is judged according to the first trajectory and the second trajectory that the distance between the first operating element and the second operating element increases.

The second generation sub-unit 124 is adapted to determine the first input action as a zooming-out action and generating a zooming-out instruction, in a case where it is judged according to the first trajectory and the second trajectory that the distance between the first operating element and the second operating element decreases; where one or more operating points forming the first trajectory and one or more operating points forming the second trajectory belong to a first part of the operating points for the first input operation.

The execution unit 13 is adapted to execute the first instruction for a first object corresponding to the first input operation.

Specifically, the first object is an object for the operation performed by the operating element on the electronic device. For example, in a case where the operating element performs an operation to a picture displayed on the display region of the display unit, the picture is the first object corresponding to the first input operation. In a case where the operating element performs an operation to a button on the electronic device, the button is the first object corresponding to the first input operation.

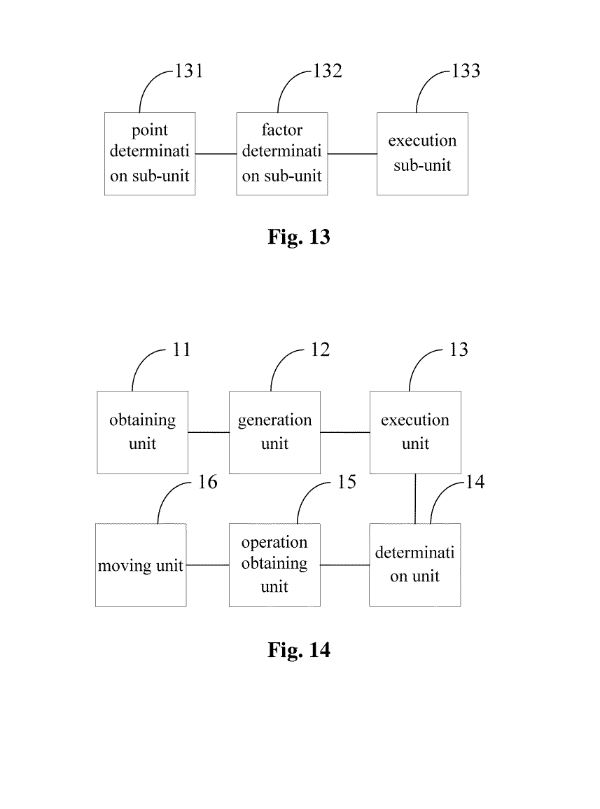

According to the embodiment of the disclosure, in the case that the generation unit 12 takes the structure as shown in FIG. 12, the execution unit 13, taking the structure as shown in FIG. 13, may include a point determination sub-unit 131, a factor determination sub-unit 132 and an execution sub-unit 133.

The point determination sub-unit 131 is adapted to determine a reference point for the first object according to a center point between a starting point of the first trajectory and a starting point of the second trajectory. Specifically, the starting point of the first trajectory and the starting point of the second trajectory are operating points corresponding to the time point when the first operating element and the second operating element are sensed by the sensing apparatus simultaneously.

The factor determination sub-unit 132 is adapted to determine a factor for responding to the first instruction according to the first trajectory and the second trajectory.

The factor for the first instruction is determined by a distance between an operating point on the first trajectory and a corresponding operating point on the second trajectory. For example, a factor for an i-th execution of the first instruction is determined by a distance between an i-th operating point of the first trajectory and an i-th operating point of the second trajectory.

In a case where the first instruction is a zooming-in instruction, the greater a distance between counterpart operating points of two trajectories is, the greater the factor for the zooming-in is; in a case where the first instruction is a zooming-out instruction, the less the distance between the counterpart operating points of the two trajectories is, the greater the factor for the zooming-in is.

The execution sub-unit 133 is adapted to respond to the first instruction according to the reference point and the factor.

Conventionally, before each execution of a zooming-in instruction or a zooming-out instruction, it is needed to recalculate the reference point for the first object corresponding to the instruction. However, according to the embodiment of the disclosure, the execution sub-unit 133 responds to the first instruction based on a reference point which has been obtained, thereby saving time.

The determination unit 14 is adapted to determine, based on the first input operation, that the first input action is completed and a gesture at the time of completion of the first input action is maintained, and trigger the execution unit to continue to execute the first instruction for the first object corresponding to the first input operation.

Specifically, the determination unit 14 includes a point obtaining sub-unit and a determination sub-unit.

The point obtaining sub-unit is adapted to obtain multiple first operating points of the first operating element and multiple second operating points of the second operating element; where a starting point of the multiple first operating points is an operating point at the end of the first trajectory, a starting point of the multiple second operating points is an operating point at the end of the second trajectory, and the multiple first operating points and the multiple second operating points belong to a second part of the operating points for the first input operation.

The determination sub-unit is adapted to determine, based on the first input operation, that the first input action is completed and a gesture at the time of completion of the first input action is maintained, in a case where a predetermined condition is satisfied by the multiple first operating points and the predetermined condition is satisfied by the multiple second operating points.

In a case where the determination sub-unit determines that the first input action is completed and a gesture at the time of completion of the first input action is maintained, the execution sub-unit 133 further continues to respond to the first instruction based on the reference point according to a predetermined factor. Since the first instruction is executed always based on the reference point for the first object determined in the first execution of the first instruction, and the reference point obtained in the first execution is closer to a position in which the user is most interested, the first instruction is executed in a region around the reference point of the first object, such that the reference point for the first object are always displayed on the display region of the display unit as much as possible.

Reference is made to FIG. 14 which shows another schematic structure diagram of an information processing apparatus according to an embodiment of the disclosure. As compared with the embodiment shown in FIG. 11, the information processing apparatus may further include:

an operation obtaining unit 15, adapted to determine an accomplishment of the first input operation; and

a moving unit 16, adapted to move, upon accomplishment of the first input operation, the first object, which is in response to the completion of the first instruction, according to a center point of a display region of a display unit of the electronic device, so that a reference point for the first object corresponds to the center point.

The information processing apparatus according to the embodiments of the disclosure may be integrated in an electronic device including a sensing apparatus, and the information processing apparatus may obtain the input operation by the first sensing apparatus. The specific process may refer to the above-described method embodiments and apparatus embodiments, which will not be further described in the embodiment.

The respective embodiments have been described progressively in this description, and each of the embodiments has been focused upon its differences from the other embodiments, so reference can be made to each other for those identical or similar points among the respective embodiments. For the apparatus disclosed according to an embodiment, it corresponds to its method disclosed according to an embodiment, so the description thereof has been simplified, and reference can be made to the relevant disclosure of the method for their relevant points.

It should be noted that the relationship terminologies such as “first”, “second” and the like are only used herein to distinguish one entity or operation from another, rather than to necessitate or imply that the actual relationship or order exists between the entities or operations. Furthermore, terms of “include”, “comprise” or any other variants are intended to be non-exclusive. Therefore, a process, method, article or device including a plurality of elements includes not only the elements but also other elements that are not enumerated, or also include the elements inherent for the process, method, article or device. Unless expressively limited otherwise, the statement “comprising (including) one . . . ” does not exclude the case that other similar elements may exist in the process, method, article or device.

The information processing method, apparatus and the electronic device according to the disclosure are described above in detail. Specific examples are set forth to specify the principle and implementation of the disclosure, and the description of the foregoing embodiments is only intended to facilitate understanding the method and core principle of the disclosure. In addition, various modifications to implementations and applications of the embodiments may be made by those skilled in the art based on the spirit of the disclosure. Therefore, the disclosure is not meant to be limited to the specification.

1. An information processing method, applied to an electronic device comprising a sensing apparatus, the method comprising:
obtaining a first input operation by the sensing apparatus, the first input operation corresponding to a first input action;
determining the first input action based on the first input operation and generating a first instruction corresponding to the first input action;
executing the first instruction for a first object corresponding to the first input operation;
determining, based on the first input operation, that the first input action is completed and a gesture at the time of completion of the first input action is maintained; and
continuing to execute the first instruction for the first object corresponding to the first input operation.

2. The information processing method according to claim 1, wherein in a case where the first instruction is a zooming-in instruction or a zooming-out instruction, the determining the first input action based on the first input operation and generating a first instruction corresponding to the first input action comprises:
obtaining a first trajectory generated by a first operating element and a second trajectory generated by a second operating element;
judging a variation trend of a distance between the first operating element and the second operating element according to the first trajectory and the second trajectory;
in a case where it is judged according to the first trajectory and the second trajectory that the distance between the first operating element and the second operating element increases, determining the first input action as a zooming-in action and generating a zooming-in instruction; and
in a case where it is judged according to the first trajectory and the second trajectory that the distance between the first operating element and the second operating element decreases, determining the first input action as a zooming-out action and generating a zooming-out instruction,
wherein one or more operating points forming the first trajectory and one or more operating points forming the second trajectory belong to a first part of the operating points for the first input operation.

3. The information processing method according to claim 2, wherein the determining, based on the first input operation, that the first input action is completed and a gesture at the time of completion of the first input action is maintained comprises:
obtaining a plurality of first operating points of the first operating element and a plurality of second operating points of the second operating element, wherein a starting operating point of the plurality of first operating points is an operating point at the end of the first trajectory, a starting operating point of the plurality of second operating points is an operating point at the end of the second trajectory, and the plurality of first operating points and the plurality of second operating points belong to a second part of the operating points for the first input operation; and
in a case where a predetermined condition is satisfied by the plurality of first operating points and the predetermined condition is satisfied by the plurality of second operating points, determining that the first input action is completed and the gesture at the time of completion of the first input action is maintained.

4. The information processing method according to claim 2, wherein the executing the first instruction for a first object corresponding to the first input operation comprises:
determining a reference point for the first object according to a center point between a starting point of the first trajectory and a starting point of the second trajectory;
determining a factor for responding to the first instruction according to the first trajectory and the second trajectory; and
responding to the first instruction based on the reference point and the factor,
wherein the starting point of the first trajectory and the starting point of the second trajectory are operating points corresponding to a time point when the first operating element and the second operating element are sensed by the sensing apparatus simultaneously.

5. The information processing method according to claim 4, wherein in a case where the first input action is completed and the gesture at the time of the completion of the first input action is maintained, the continuing to execute the first instruction for the first object corresponding to the first input operation comprises:
continuing to respond to the first instruction with a predetermined factor based on the reference point.

6. The information processing method according to claim 1, further comprising:
determining an accomplishment of the first input operation; and
upon accomplishment of the first input operation, moving, according to a center point of a display region of a display unit of the electronic device, the first object which is in response to the completion of the first instruction, so that a reference point for the first object corresponds to the center point.

7. An information processing apparatus, applied to an electronic device comprising a sensing apparatus, the information processing apparatus comprising:
an obtaining unit, adapted to obtain a first input operation by the sensing apparatus, the first input operation corresponding to a first input action;
a generation unit, adapted to determine the first input action based on the first input operation and generate a first instruction corresponding to the first input action;
an execution unit, adapted to execute the first instruction for a first object corresponding to the first input operation; and
a determination unit, adapted to determine, based on the first input operation, that the first input action is completed and a gesture at the time of completion of the first input action is maintained, and trigger the execution unit to continue to execute the first instruction for the first object corresponding to the first input operation.

8. The information processing apparatus according to claim 7, wherein in a case where the first instruction is a zooming-in instruction or a zooming-out instruction, the generation unit comprises:
an obtaining sub-unit, adapted to obtain a first trajectory generated by a first operating element and a second trajectory generated by a second operating element;
a judgment sub-unit, adapted to judge a variation trend of a distance between the first operating element and the second operating element according to the first trajectory and the second trajectory;
a first generation sub-unit, adapted to determine the first input action as a zooming-in action and generate a zooming-in instruction, in a case where it is judged according to the first trajectory and the second trajectory that the distance between the first operating element and the second operating element increases; and
a second generation sub-unit, adapted to determine the first input action as a zooming-out action and generating a zooming-out instruction, in a case where it is judged according to the first trajectory and the second trajectory that the distance between the first operating element and the second operating element decreases,
wherein one or more operating points forming the first trajectory and one or more operating points forming the second trajectory belong to a first part of the operating points for the first input operation.

9. The information processing apparatus according to claim 8, wherein the determination unit comprises:
a point obtaining sub-unit, adapted to obtain a plurality of first operating points of the first operating element and a plurality of second operating points of the second operating element, wherein a starting operating point of the plurality of first operating points is an operating point at the end of the first trajectory, a starting operating point of the plurality of second operating points is an operating point at the end of the second trajectory, and the plurality of first operating points and the plurality of second operating points belong to a second part of the operating points for the first input operation; and
a determination sub-unit, adapted to determine that the first input action is completed and the gesture at the time of completion of the first input action is maintained, in a case where a predetermined condition is satisfied by the plurality of first operating points and the predetermined condition is satisfied by the plurality of second operating points.

10. The information processing apparatus according to claim 8, wherein the execution unit comprises:
a point determination sub-unit, adapted to determine a reference point for the first object according to a center point between a starting point of the first trajectory and a starting point of the second trajectory;
a factor determination sub-unit, adapted to determine a factor for responding to the first instruction according to the first trajectory and the second trajectory; and
an execution sub-unit, adapted to respond to the first instruction based on the reference point and the factor,
wherein the starting point of the first trajectory and the starting point of the second trajectory are operating points corresponding to a time point when the first operating element and the second operating element are sensed by the sensing apparatus simultaneously.

11. The information processing apparatus according to claim 10, wherein the execution sub-unit is further adapted to continue to respond to the first instruction with a predetermined factor based on the reference point.

12. The information processing apparatus according to claim 7, further comprising:
an operation obtaining unit, adapted to determine an accomplishment of the first input operation; and
a moving unit, adapted to move, upon accomplishment of the first input operation, the first object, which is in response to the completion of the first instruction, according to a center point of a display region of a display unit of the electronic device, so that a reference point for the first object corresponds to the center point.

13. An electronic device comprising:
a sensing apparatus, and
an information processing apparatus, wherein the information processing apparatus comprises:
an obtaining unit, adapted to obtain a first input operation by the sensing apparatus, the first input operation corresponding to a first input action;
a generation unit, adapted to determine the first input action based on the first input operation and generate a first instruction corresponding to the first input action;
an execution unit, adapted to execute the first instruction for a first object corresponding to the first input operation; and
a determination unit, adapted to determine, based on the first input operation, that the first input action is completed and a gesture at the time of completion of the first input action is maintained, and trigger the execution unit to continue to execute the first instruction for the first object corresponding to the first input operation.

14. The electronic device according to claim 13, wherein in a case where the first instruction is a zooming-in instruction or a zooming-out instruction, the generation unit comprises:
an obtaining sub-unit, adapted to obtain a first trajectory generated by a first operating element and a second trajectory generated by a second operating element;
a judgment sub-unit, adapted to judge a variation trend of a distance between the first operating element and the second operating element according to the first trajectory and the second trajectory;
a first generation sub-unit, adapted to determine the first input action as a zooming-in action and generate a zooming-in instruction, in a case where it is judged according to the first trajectory and the second trajectory that the distance between the first operating element and the second operating element increases; and
a second generation sub-unit, adapted to determine the first input action as a zooming-out action and generating a zooming-out instruction, in a case where it is judged according to the first trajectory and the second trajectory that the distance between the first operating element and the second operating element decreases,
wherein one or more operating points forming the first trajectory and one or more operating points forming the second trajectory belong to a first part of the operating points for the first input operation.

15. The electronic device according to claim 14, wherein the determination unit comprises:
a point obtaining sub-unit, adapted to obtain a plurality of first operating points of the first operating element and a plurality of second operating points of the second operating element, wherein a starting operating point of the plurality of first operating points is an operating point at the end of the first trajectory, a starting operating point of the plurality of second operating points is an operating point at the end of the second trajectory, and the plurality of first operating points and the plurality of second operating points belong to a second part of the operating points for the first input operation; and
a determination sub-unit, adapted to determine that the first input action is completed and the gesture at the time of completion of the first input action is maintained, in a case where a predetermined condition is satisfied by the plurality of first operating points and the predetermined condition is satisfied by the plurality of second operating points.

16. The electronic device according to claim 14, wherein the execution unit comprises:
a point determination sub-unit, adapted to determine a reference point for the first object according to a center point between a starting point of the first trajectory and a starting point of the second trajectory;
a factor determination sub-unit, adapted to determine a factor for responding to the first instruction according to the first trajectory and the second trajectory; and
an execution sub-unit, adapted to respond to the first instruction based on the reference point and the factor,
wherein the starting point of the first trajectory and the starting point of the second trajectory are operating points corresponding to a time point when the first operating element and the second operating element are sensed by the sensing apparatus simultaneously.

17. The electronic device according to claim 16, wherein the execution sub-unit is further adapted to continue to respond to the first instruction with a predetermined factor based on the reference point.

18. The electronic device according to claim 13, further comprising:
an operation obtaining unit, adapted to determine an accomplishment of the first input operation; and
a moving unit, adapted to move, upon accomplishment of the first input operation, the first object, which is in response to the completion of the first instruction, according to a center point of a display region of a display unit of the electronic device, so that a reference point for the first object corresponds to the center point.
